(19) United States
(12) Patent Application Publication
(10) Pub. No.: US 2025/0274808 A1
(43) Pub. Date: Aug. 28, 2025

(54) Early Quality of Service Assurance

(71) Applicant: Apple Inc., Cupertino, CA (US)

(72) Inventors: Abdel Karim Ajami, Cupertino, CA (US); Yong Liu, Campbell, CA (US); Brajesh K. Dave, Cupertino, CA (US); Jinjing Jiang, San Jose, CA (US); Anuj Batra, Redwood City, CA (US); Oren Shani, Cupertino, CA (US); Veerendra Boodannavar, Cupertino, CA (US); Jarkko L. Kneckt, Los Gatos, CA (US)

(21) Appl. No.: 19/057,734

(22) Filed: Feb. 19, 2025

Related U.S. Application Data
(60) Provisional application No. 63/559,006, filed on Feb. 28, 2024.

(51) Int. Cl. H04W 28/02; H04W 88/10

(52) U.S. Cl. CPC H04W 28/0268; H04W 88/10

(57) ABSTRACT

This disclosure relates to methods for early QoS assurance within a roaming MLD, e.g., methods that can allow a client station to gain knowledge about QoS support of target APs prior to roaming (e.g., attaching) to the target AP within the roaming MLD. In addition, methods can allow a client station to gain knowledge about QoS support of target APs within an MLD that a client station is not associated with (e.g., prior to the client associating (e.g., attaching) to the MLD). Further, methods can allow an SCS agreement to be applicable across all APs of an AP MLD or to be applicable at a particular AP of an AP MLD. Additionally, methods can provide enhanced SCS agreement functionality to support roaming between AP MLDs.

### PRIORITY DATA

This application claims benefit of priority to U.S. Provisional Application Ser. No. 63/559,006, titled “Early Quality of Service Assurance”, filed Feb. 28, 2024, which is hereby incorporated by reference in its entirety as though fully and completely set forth herein.

### TECHNICAL FIELD

The present application relates to wireless communication, including techniques and devices for early assurance of Quality of Service (QOS) when roaming in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for early assurance of Quality of Service (QOS) when roaming in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links or can be an access point configured to establish a connection with one or more other wireless devices through a WLAN over one or multiple wireless links. The wireless device can operate in each of the multiple wireless links using a respective radio of the one or more radios.

For example, a wireless device can be configured to transmit, to a first access point (AP) of a multi-link device (MLD) AP, a request frame soliciting feedback regarding quality of service (QoS) support of a QoS flow through the MLD AP. Additionally, the wireless device can be configured to receive, from a serving AP of the MLD AP, a response frame that includes an indication of whether or not at least one of one or more target APs within a mobility domain of the MLD AP can support the QoS flow.

As another example, a wireless device can be configured to receive, from a first access point (AP) of a multi-link device (MLD) AP, a roaming recommendation/request frame that indicates quality of service (QOS) support of a QoS flow through the MLD AP. Additionally, the wireless device can be configured to transmit, to a serving AP of the MLD AP, a roaming request frame based, at least in part, on information included in the roaming recommendation/request frame.

As a further example, a wireless device can be configured to receive, from an access point (AP) of a multi-link device (MLD) AP, a frame that includes an indication of QoS classes supported by the AP prior to establishing a security context with the AP. Further, the wireless device can be configured to base a determination on whether to associate with the AP at least partly on the indication of QoS classes supported by the AP.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments.

FIG. 2 is a block diagram illustrating an example wireless device, according to some embodiments.

FIG. 3 is a block diagram illustrating an example network element or access point, according to some embodiments.

FIG. 4 is a block diagram illustrating an example modem or baseband processor, according to some embodiments.

FIGS. 5A, 5B, 5C, and 5D illustrate examples of a wireless station roaming.

FIG. 6 is an example of signaling for supporting early QoS assurance within a roaming MLD, according to some embodiments.

FIG. 7 is another example of signaling for supporting early QoS assurance within a roaming MLD, according to some embodiments.

FIG. 8A is an example of signaling for supporting early QoS assurance prior to association to an AP, according to some embodiments.

FIG. 8B is an example of signaling for supporting early QOS assurance prior to association to an AP, according to some embodiments.

FIG. 8C is another example of signaling for supporting early QoS assurance prior to association to an AP, according to some embodiments.

FIGS. 9A, 9B, and 9C illustrate various aspects of a QoS class information element, according to some embodiments.

FIGS. 10, 11, and 12 are examples of methods for supporting early QOS assurance, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

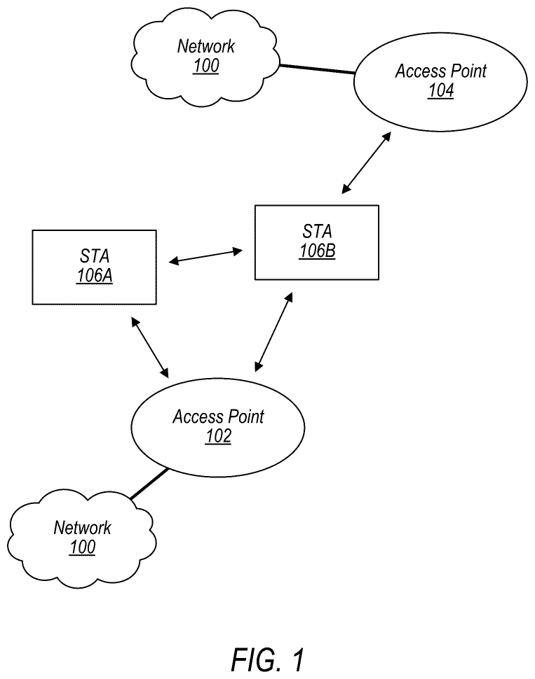

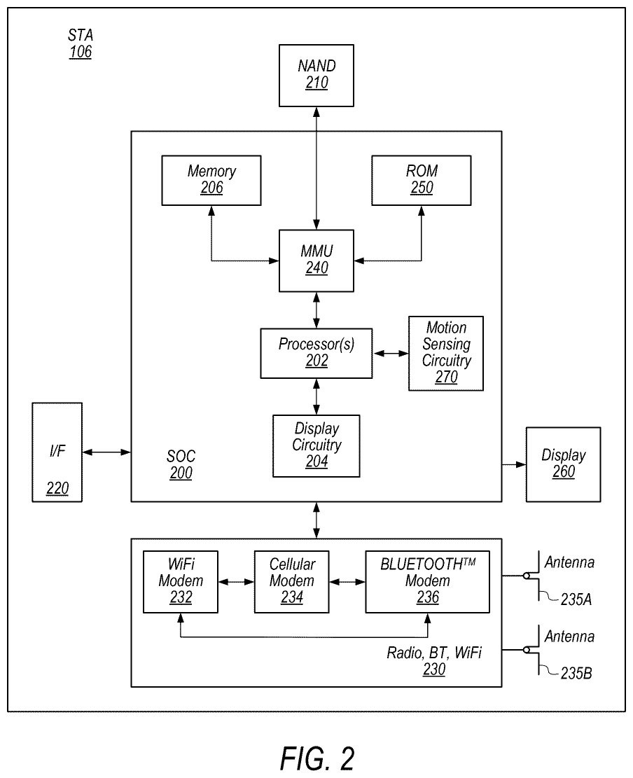

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or WLAN devices.

The STA 106 can be a device with wireless network connectivity such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any type of wireless device. The STA 106 can include a processor (processing element) that is configured to execute program instructions stored in memory. The STA 106 can perform any of the methods described herein by executing such stored instructions. Alternatively, or in addition, the STA 106 can include a programmable hardware element such as an FPGA (field-programmable gate array), an integrated circuit, and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more global satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can be able to connect to either or both of AP 102 (or another cellular base station) and the access point 104 (or another access point) to access the network 100. For example, a STA can roam from AP 102 to AP 104 based on one or more factors, such as coverage, interference, and capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment such as an appliance, measurement device, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for early assurance of Quality of Service (QOS) when roaming in a wireless communication system, such as according to the various methods described herein. Alternatively, or In addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies. In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202 which can execute program instructions for the STA 106, and display circuitry 204 which can perform graphics processing and provide display signals to the display 260. The SOC 200 can also include motion sensing circuitry 270 which can detect motion of the STA 106, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances multiple antennas 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be a cellular modem capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for early assurance of Quality of Service (QOS) when roaming described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

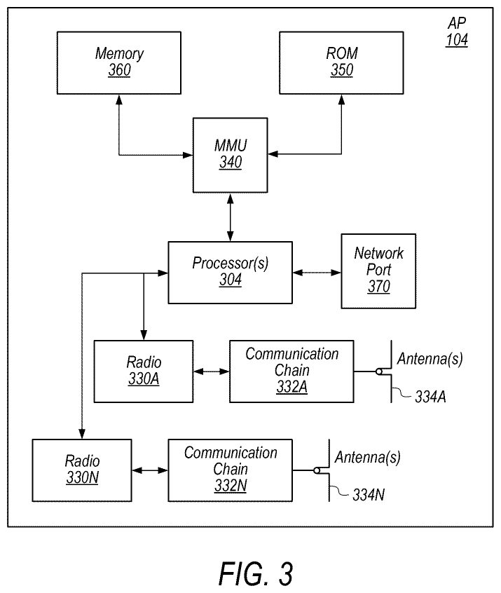

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, each of which can be coupled to a respective communication chain and at least one antenna 334, and possibly multiple antennas. The antenna(s) 334 can be configured to operate as a wireless transceiver and can be further configured to communicate with STA devices 106 via radios 330A-330N. Note that one or more of the radios 330A-330N can be configured for MLO, e.g., as described above. The antenna(s) 334A-N communicate with their respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, UWB, Wi-Fi, BT, etc. The AP 104 can be configured to operate on multiple wireless links using the one or more radios 330A-N, wherein each radio is used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology as well as a Wi-Fi radio for performing communication according to Wi-Fi. In such a case, the AP 104 can be capable of operating as both a cellular base station and a Wi-Fi access point. As another possibility, the AP 104 can include a multi-mode radio, which is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as early assurance of Quality of Service (QOS) when roaming, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

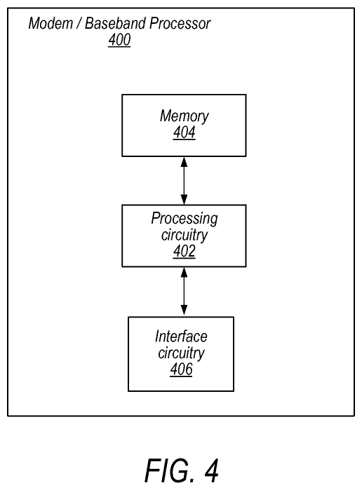

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device and can have an additional indirect interface with an application processor and/or other components of the wireless device by way of a system bus. Other configurations are also possible.

In at least some instances, the hardware and software components of the modem 400 can be configured to implement or support implementation of features described herein, such as early assurance of Quality of Service (QOS) when roaming, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

### Early QoS Assurance

In current implementations, maintaining a quality of service (QOS) while roaming to an access point (AP) remains a challenge for a wireless device. A common issue is ether a “best” scored AP will accept a Stream Classification Service (SCS) request from a client that has a QoS session. Note that SCS is a Wi-Fi QoS management feature that classifies Internet Protocol (IP) flows and treats them according to a Quality of Service (QOS). Note that SCS, introduced in WiFi 7, identifies real-time applications and ensures that data streams requiring low latency handling, such as online gaming, instant messaging, and streaming video, receive the appropriate QoS priority treatment. Thus, SCS allows sensitive traffic like voice, video, and gaming to be prioritized over bulk data traffic. In current implementations, SCS uses four algorithms, including a Path Selection Algorithm (e.g., which finds neighboring node at a “shortest” distance to reduce delay), a Routing Algorithm (e.g., which hops data packets via different nodes), and a Mobility Algorithm (e.g., which can decrease transmission time). Further, SCS allows a device (e.g., a user of a device) to select priority (UP), drop eligibility, and Enhanced Distributed Channel Access (EDCA) transmit queue based on a medium access control (MAC) Service Data Unit (MSDU) classification.

IEEE 802.11be introduced a QoS Characteristics element in the SCS protocol to allow a client to request an associated AP to trigger the client in the uplink or serve the client in the downlink based on a set of parameters, e.g., such as Service Start Time, Min and Max Service Interval, Min Data Rate, and so forth. Further, IEEE 802.11be defined the SCS agreement at the MLD level and is terminated when a client associates with a new MLD.

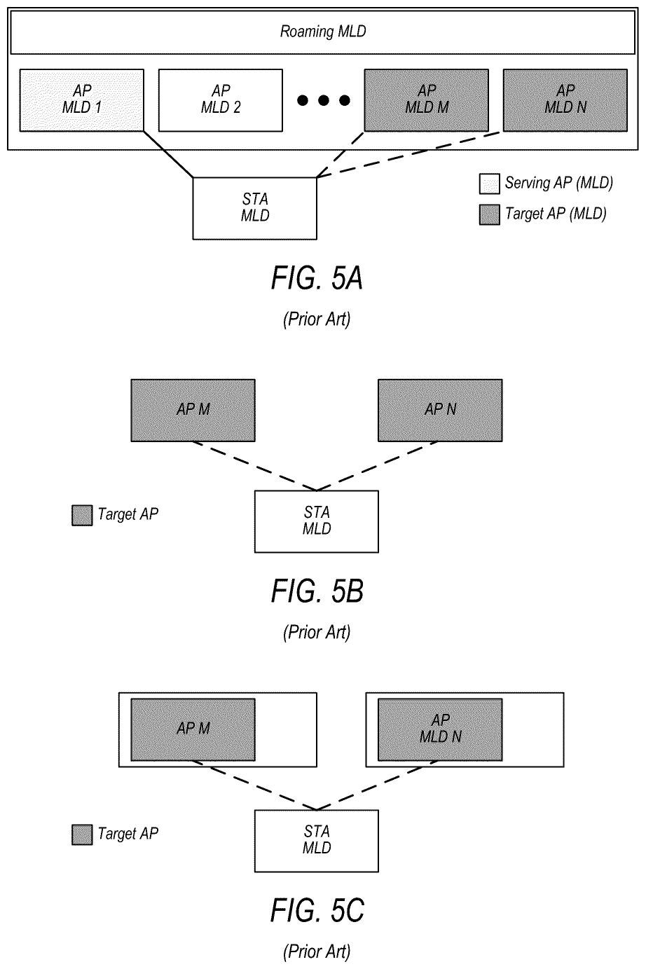

However, as a client (e.g., wireless station) roams from one AP to another AP, the client has no visibility about the support of its QoS flows at a target AP and it can be highly undesirable for the client that has an ongoing QoS session (or about to start a new QoS session) to roam to a target AP that does not support the QoS. In such instances, the target AP can end rejecting the SCS request leading to unnecessary delays (e.g., a delay needed to switch the data path and start serving the client). For example, FIGS. 5A, 5B, and 5C illustrate example scenarios in which a client roams to an AP that is not capable of supporting a QoS flow of the client. As shown in FIG. 5A, the client (STA MLD) may be roaming from one AP MLD (e.g., AP MLD1) to a target AP MLD (e.g., AP MLD M or AP MLD N) within a Roaming MLD (e.g., an entity that can manage all MLDs within an AP, e.g., all MLDs within a mobility domain of the AP). Similarly, as shown in FIG. 5B, the client (e.g., STA MLD) may be entering a new location and attempting to connect to a target AP (e.g., Ap M or AP N), and, as shown in FIG. 5C, the target AP can be a part of an MLD/seamless roaming AP MLD (e.g., AP MLD N) or not part of an MLD/seamless roaming AP MLD (e.g., AP M). Note that a seamless roaming AP MLD can be define as an entity that can manage one or more APs or AP MLDs. Note further that such an entity may or may not reside in one of the AP MLDs. In all scenarios, the client may end up roaming to an AP and/or AP MLD that is not capable of supporting the QoS requirements of the client, which can lead to unnecessary delays. Also, in some deployments, a network can steer a client to an AP that can later reject the client's SCS request and in such case, the client has no clue knowledge there is another AP (which could be on another channel) that can support the client's SCS request.

In addition, when a client (e.g., a non-AP MLD) is roaming from a current AP MLD to a target AP MLD, the target AP MLD may have existing SCS agreements with one or more other non-AP MLDs, e.g., as illustrated by FIG. 5D. As shown, a current AP MLD (e.g., AP MLD 1) may have an SCS agreement with the client (e.g., SCSID 1 of AP MLD 1) that specifies SCS parameters for a QoS session of the client. Similarly, a target AP MLD (e.g., AP MLD 2) may have an SCS agreement with another client (e.g., SCSID 1 of AP MLD 2) that specifies SCS parameters for a QoS session of the other client. However, for the client that is roaming, it is unclear whether the target AP MLD can support its QoS session. For example, the target AP MLD could have the QoS resources required by the client and only a service start time needs to specified with the target AP MLD (note that for a direct link, medium time and a link identifier may need to be specified with respect to the target AP MLD since different links can lead to different medium time), the target AP MLD could have available QoS resources but cannot provide the same QoS parameters as the current AP MLD (e.g., such as minimum/maximum service interval, minimum data rate, medium time, and so forth) and an application supported by the QoS session may not be able to adapt to suggested SCS parameters by the target AP MLD upon roaming, and/or the target AP MLD may not have required QoS resources (in which case it may be preferable to avoid roaming to the target AP MLD and switch to a cellular link, if available). However, SCS design in current implementations do not allow the client to know prior to roaming the status of the target AP MLD.

Therefore, improvements are desired.

Embodiments described herein provide systems, methods, and mechanisms for early QoS assurance within a roaming MLD, e.g., the systems, methods, and mechanisms can allow a client station to gain knowledge about QoS support of target APs prior to roaming (e.g., attaching) to the target AP within the roaming MLD. In addition, systems, methods, and mechanisms described herein can allow a client station to gain knowledge about QoS support of target APs within an MLD (e.g., within a mobility domain of the MLD) that client is not associated with (e.g., prior to the client associating (e.g., attaching) to the MLD). Further, systems, methods, and mechanisms described herein can allow an SCS agreement to be applicable across all APs of an AP MLD or to be applicable at a particular AP of an AP MLD. Additionally, systems, methods, and mechanisms described herein provide enhanced SCS agreement functionality to support roaming between AP MLDs.

Note that a mobility domain can refer to a logical grouping of access points (APs) and/or MLDs, within which seamless roaming is supported. Such a domain can facilitate a smooth transition of a client device (e.g., such as non-AP STA 106) between different APs and/or different MLD entities, maintaining a consistent connection and minimizing disruptions. Note further that a mobility domain can provide a framework to manage roaming across MLDs and/or APs. For example, a mobility domain can be defined to encompass multiple APs, allowing the APs to function as a single, unified entity (e.g., such as AP 104 described herein) for roaming purposes within the mobility domain. As another example, a mobility domain can be defined as a logical entity (e.g., such as AP 104 described herein) that manages seamless roaming across multiple AP MLDs.

For example, a client (e.g., a non-AP STA, such as STA 106, which can be an MLD device), can gain early knowledge about QoS support by an access point, such as AP 104, prior to roaming to a target AP MLD of the AP 104. Thus, the client can send an early request to a current/serving AP MLD to solicit feedback about QoS support for a new or an ongoing QoS flow. Such an early QoS assurance request can include one or more QoS characteristics elements with a description of the QoS flows (e.g., uplink flows, downlink flows, and/or peer-to-peer flows) in addition to other elements like type classification (TCLAS) (for uplink and/or downlink), behavior aggregate (BA) classification, capabilities, and optionally one or more AP MLDs of interest. The early QoS assurance request (e.g., request) can be sent through a current AP MLD or directly to a target AP MLD. Note that the request (and/or response frame) can be sent as a standalone frame, use one or more fields and/or elements in an existing frame, and/or use one or more fields and/or elements in a newly defined frame. Additionally, there can be one or more capability and/or operation mode elements as part of the request to indicate support of these functionalities at the AP (e.g., AP MLD) and/or the non-AP (e.g., non-AP MLD).

In addition, in some instances, a request can be simplified (e.g., such as to ask to continue a current SCS agreement) by including one or more SCSID(s) of current SCS agreements, if any. The client can expect the AP to send a response (which could be tunneled through the current AP MLD) with acceptance or rejection (with suggested changes, e.g., such as reduced bandwidth, reduced data rate, and so forth). The response can include a timeout interval by which the client needs to roam within a Virtual MLD (e.g., a Seamless Roaming AP MLD) so that the QoS is assured. Note that a seamless roaming AP MLD can be defined as an entity that can manage one or more APs or AP MLDs. Note further that such an entity may or may not reside in one of the AP MLDs. Additionally, note that upon roaming of the client within the timeout interval with an approved request, the AP is expected to accept the SCS agreement and resume an existing SCS agreement. In addition, the client can confirm the SCS agreement during a roaming sequence. In some instances, the request can be a variation of an SCS request variant with an of an early Request or Response in the SCS Request Type. In other instances, the request may be an action frame specifically define for early QoS assurance. Note that such a scheme can be used with an AP even without a security context (which is less preferable) and/or a client can establish authentication/security context explicitly for roaming.

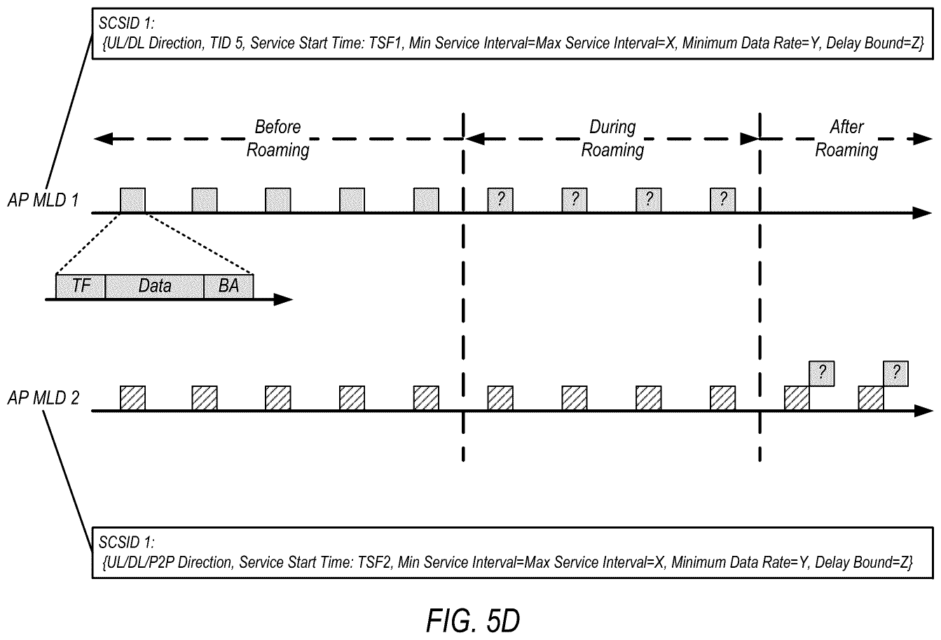

FIG. 6 is an example of signaling for supporting early QoS assurance within a roaming MLD, according to some embodiments. In various scenarios, some of the elements of the signaling shown can be performed concurrently, in a different order than shown, can be substituted for by one or more other signals, or can be omitted. Additional signaling can also be performed as desired.

Aspects of the signaling of FIG. 6 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling.

Note that while at least some signaling of FIG. 6 are described in a manner relating to the use of communication techniques and/or features associated with IEEE 802.11 specification documents, such description is not intended to be limiting to the disclosure, and aspects of the signaling of FIG. 6 can be used in any suitable wireless communication system, as desired. As shown, the signaling can operate as follows.

The signaling can begin with a non-access point wireless station (e.g., such as a baseband processor of a non-access point wireless station), such as non-AP STA 106, which can be a wireless station 106, as described above, transmitting an association request frame 602 to an access point (AP) of a multi-link AP, such as AP MLD 1 of AP 104.

As shown, AP MLD 1 can respond with an association response frame 604 that associates the non-AP STA 106 to AP MLD 1. Further, at 606, the non-AP STA 106 can detect and/or initiate a QoS session and transmit an SCS request frame 608 to AP MLD 1. AP MLD 1 can respond with an SCS response frame 610. At this point, one or more QoS flows based on the SCS request/response can be established between non-AP STA 106 and AP MLD 1.

At 612, non-AP STA 106 can enter a roaming condition and/or performance at non-AP STA 106 can deteriorate. In response, non-AP STA 106 can transmit an early QoS request frame 614 to AP MLD 1 and receive an early QoS response frame 616 from AP MLD 1. The early QoS request frame 614 can be transmitted to a particular AP MLD and/or broadcasted to all AP MLDs (e.g., within a mobility domain of AP 104) and can include parameters such as one or more SCSIDs (SCS identifiers), QoS characteristics, service start time, TCLAS, and so forth for each target AP MLD. The early QoS response frame 616 can include parameters such an indication of acceptance or rejection, SCSIDs, a timeout period of the acceptance, and so forth for each target AP MLD. Note that a rejection indication may include suggested changes in order for a particular target AP MLD to accept the QoS flow, Further, non-AP STA 106 can transmit a roaming request frame 618 to AP MLD 1 and receive a roaming response frame 620 from AP MLD 1. The roaming request frame 618 can include an SCSID, QoS characteristics, and so forth and can request a datapath switch to a target AP MLD. The roaming response frame 620 can indicate a target AP MLD to roam to as well as an SCSID, service start time, and so forth. Upon receipt of the roaming response frame 620, the non-AP STA 106 can then attempt to associate with the indicated target AP MLD with assurance that the QoS flow will be supported by the indicated target AP MLD.

Thus, according to the signaling of FIG. 6, it can be possible for a client to gain early knowledge about QoS support by an AP prior to roaming to a target AP MLD of the AP (e.g., where the target AP MLD is within a mobility domain of the AP), for example to provide better handling for low latency traffic during roaming events, among various possibilities. Such techniques can provide improved latency for QoS flows when roaming and/or provide any of a variety of other possible benefits, at least according to some embodiments.

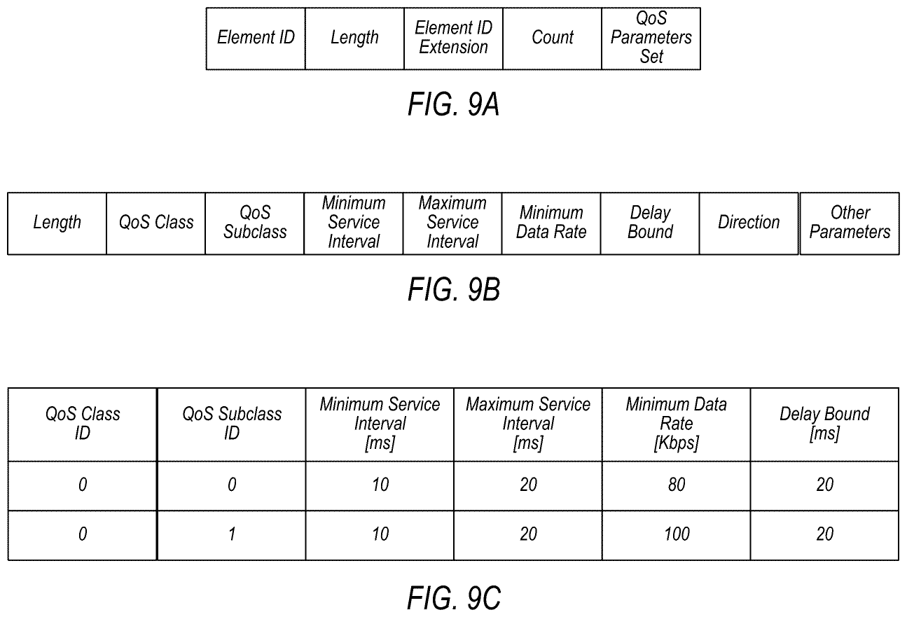

As another example, in some deployments, an AP, such as AP 104 can send an unsolicited roaming recommendation/request frame (e.g., a broadcast and/or management frame) to steer a client, such as non-AP STA 106, to another AP, e.g., to another AP MLD (e.g., that is within a mobility domain of the AP 104). The AP can include a candidate list describing the preferences for target candidate AP MLDs. In some instances, the AP can include information regarding which of the candidate AP MLDs is capable of supporting an existing SCS agreement or QoS classes (e.g., as described below in reference to FIGS. 9A, 9B, and 9C) for a particular client, e.g., such as non-AP STA 106. In addition, a client can setup and/or update an existing SCS agreement in a roaming sequence (including association) via inclusion of an SCS descriptor element/QoS characteristics element in a roaming request to the AP and inclusion of an SCS status list and SCS descriptor element (e.g., with QoS characteristics element) in a roaming response, e.g., to confirm continuation of the SCS agreement and indicate necessary parameters for a service start time.

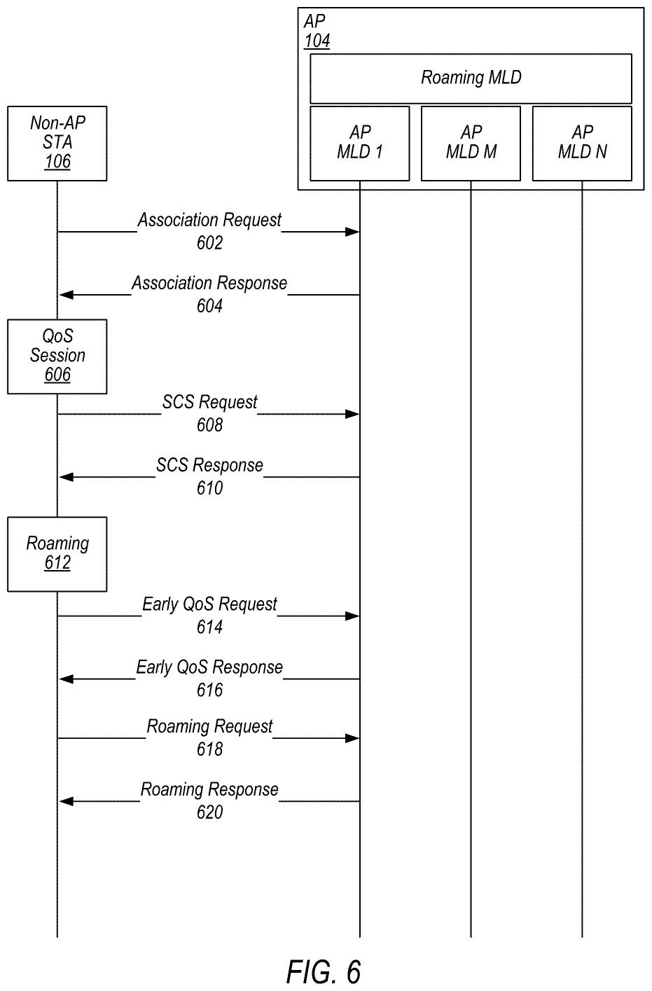

FIG. 7 is another example of signaling for supporting early QoS assurance within a roaming MLD, according to some embodiments. In various scenarios, some of the elements of the signaling shown can be performed concurrently, in a different order than shown, can be substituted for by one or more other signals, or can be omitted. Additional signaling can also be performed as desired.

Aspects of the signaling of FIG. 7 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling.

Note that while at least some signaling of FIG. 7 are described in a manner relating to the use of communication techniques and/or features associated with IEEE 802.11 specification documents, such description is not intended to be limiting to the disclosure, and aspects of the signaling of FIG. 7 can be used in any suitable wireless communication system, as desired. As shown, the signaling can operate as follows.

The signaling can begin with a non-access point wireless station (e.g., such as a baseband processor of a non-access point wireless station), such as non-AP STA 106, which can be a wireless station 106, as described above, transmitting an association request frame 702 to an access point (AP) of a multi-link AP, such as AP MLD 1 of AP 104.

As shown, AP MLD 1 can respond with an association response frame 704 that associates the non-AP STA 106 to AP MLD 1. Further, at 706, the non-AP STA 106 can detect and/or initiate a QoS session and transmit an SCS request frame 708 to AP MLD 1. AP MLD 1 can respond with an SCS response frame 710. At this point, one or more QoS flows based on the SCS request/response can be established between non-AP STA 106 and AP MLD 1.

At 712, non-AP STA 106 can enter a roaming condition and/or performance at non-AP STA 106 can deteriorate. Non-AP STA 106 can receive a roaming recommendation frame 714 from AP MLD 1 (e.g., which can be unsolicited) and transmit a roaming response frame 716 to AP MLD 1. The roaming recommendation frame 714 can be a broadcast and/or management frame and can steer non-AP STA 106, to another AP, e.g., to another AP MLD within AP 104 (e.g., within a mobility domain of AP 104). The roaming recommendation frame 714 can include a candidate list describing the preferences for target candidate AP MLDs (e.g., such as AP MLD M and/or AP MLD N). In some instances, AP 104 can include information regarding which of the candidate AP MLDs is capable of supporting the existing SCS agreement and/or QoS classes (e.g., as described below in reference to FIGS. 9A, 9B, and 9C) for non-AP STA 106.

After transmitting the roaming response frame 716 (e.g., which may be and/or function as an acknowledgement of the roaming recommendation frame 714), non-AP STA 106 can setup and/or update an existing SCS agreement in a roaming sequence (including association) via inclusion of an SCS descriptor element/QoS characteristics element in a roaming request frame 718 to AP MLD 1. AP MLD 1 can respond with inclusion of an SCS status list and SCS descriptor element (e.g., with QoS characteristics element) in a roaming response frame 720, e.g., to confirm continuation of the SCS agreement and indicate necessary parameters for a service start time.

Thus, according to the signaling of FIG. 7, it can be possible for a client to gain early knowledge about QoS support by an AP prior to roaming to a target AP MLD of the AP via proactive signaling from the AP, for example to provide better handling for low latency traffic during roaming events and/or performance degradation, among various possibilities. Such techniques can provide improved latency for QoS flows when roaming and/or provide any of a variety of other possible benefits, at least according to some embodiments.

In some instances, e.g., prior to a security context being established, a list of QoS classes (e.g., as described below in reference to FIGS. 9A, 9B, and 9C) can be defined and can then be mapped to potential accepted SCS requests from a client. Thus, an AP can be include in unprotected frames such as a multi-link (ML) probe response frames and/or beacon frames, QoS classes that can be supported. Such a scheme can allow a client to make an informed roaming/association decision. In addition, in some instances, roaming and/or associate request frames can be leveraged to carry an SCS descriptor, QoS characteristics, and/or other necessary elements.

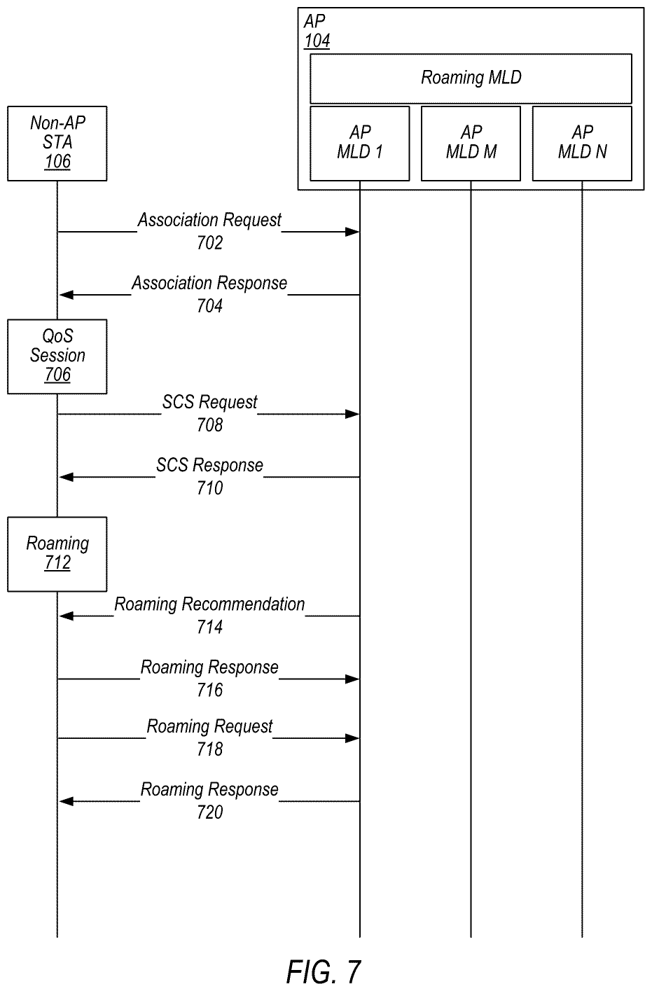

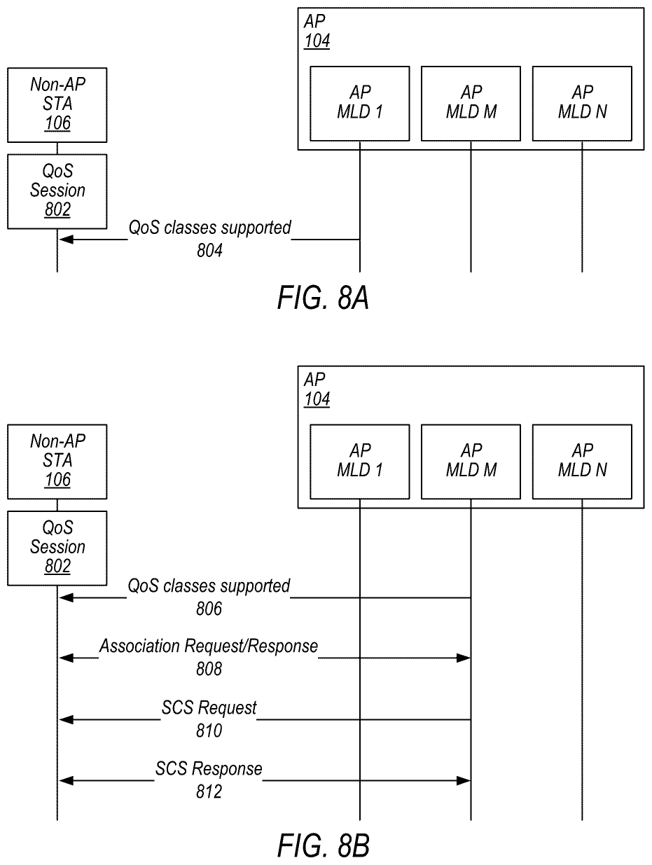

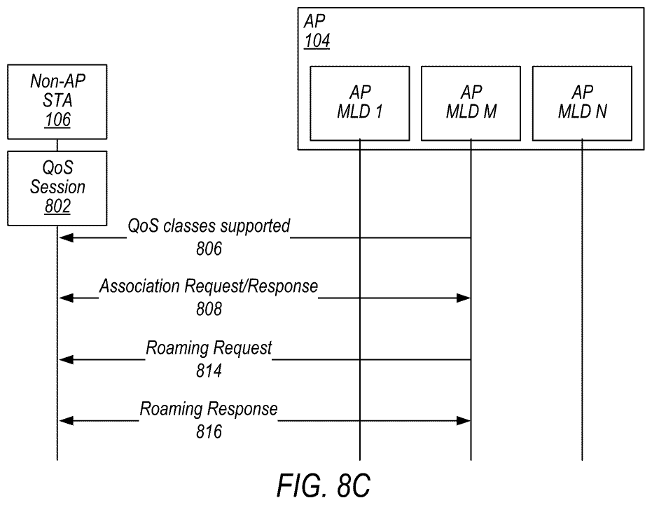

FIG. 8A is an example of signaling for supporting early QoS assurance prior to association to an AP, according to some embodiments. In various scenarios, some of the elements of the signaling shown can be performed concurrently, in a different order than shown, can be substituted for by one or more other signals, or can be omitted. Additional signaling can also be performed as desired.

Aspects of the signaling of FIG. 8A can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling.

Note that while at least some signaling of FIG. 8A are described in a manner relating to the use of communication techniques and/or features associated with IEEE 802.11 specification documents, such description is not intended to be limiting to the disclosure, and aspects of the signaling of FIG. 8A can be used in any suitable wireless communication system, as desired. As shown, the signaling can operate as follows.

The signaling can begin with a non-access point wireless station (e.g., such as a baseband processor of a non-access point wireless station), such as non-AP STA 106, which can be a wireless station 106, detecting and/or initiating a QoS session at 802. Further, the non-AP STA 106 can receive, in unprotected frames such as multi-link (ML) probe response frame/beacon frame 804, QoS classes that can be supported by AP 104, e.g., by AP MLD 1, AP MLD M, and/or AP MLD N. Upon receipt of the ML probe response frame/beacon frame, non-AP STA 106 can make an informed roaming/association decision, e.g., based, at least in part, on the indicated QoS classes that can be supported by AP MLDs 104a, 104m, and 104n.

Thus, according to the signaling of FIG. 8A, it can be possible for a client to gain early knowledge about QoS support by an AP prior to association to a target AP MLD of the AP via proactive signaling from the AP, for example to provide better handling for low latency traffic during roaming events and/or performance degradation, among various possibilities. Such techniques can provide improved latency for QoS flows when roaming and/or provide any of a variety of other possible benefits, at least according to some embodiments.

FIG. 8B is an example of signaling for supporting early QoS assurance prior to association to an AP, according to some embodiments. In various scenarios, some of the elements of the signaling shown can be performed concurrently, in a different order than shown, can be substituted for by one or more other signals, or can be omitted. Additional signaling can also be performed as desired.

Aspects of the signaling of FIG. 8B can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling.

Note that while at least some signaling of FIG. 8B are described in a manner relating to the use of communication techniques and/or features associated with IEEE 802.11 specification documents, such description is not intended to be limiting to the disclosure, and aspects of the signaling of FIG. 8B can be used in any suitable wireless communication system, as desired. As shown, the signaling can operate as follows.

The signaling can begin with a non-access point wireless station (e.g., such as a baseband processor of a non-access point wireless station), such as non-AP STA 106, which can be a wireless station 106, detecting and/or initiating a QoS session at 802. Further, the non-AP STA 106 can receive, in unprotected frames such as multi-link (ML) probe response frame/beacon frame 806, QoS classes that can be supported by AP MLD M of AP 104. Upon receipt of the ML probe response frame/beacon frame, non-AP STA 106 can make an informed roaming/association decision, e.g., based, at least in part, on the indicated QoS classes that can be supported by AP MLD M. Foor example, based on the indicated QoS classes included in ML probe response frame/beacon frame 806, non-AP STA 106 can perform association with AP MLD M, e.g., via association request/response frame 808. Further, the non-AP STA 106 can then setup a QoS flow via SCS request frame 810 (e.g., which can include an SCSID, QoS characteristics, and so forth) and SCS response frame 812 (e.g., which can include the SCSID, and an indication of successful establishment of the QoS flow).

Thus, according to the signaling of FIG. 8B, it can be possible for a client to gain early knowledge about QoS support by an AP prior to association to a target AP MLD of the AP via proactive signaling from the AP, for example to provide better handling for low latency traffic during roaming events and/or performance degradation, among various possibilities. Such techniques can provide improved latency for QoS flows when roaming and/or provide any of a variety of other possible benefits, at least according to some embodiments.

FIG. 8C is another example of signaling for supporting early QoS assurance prior to association to an AP, according to some embodiments. In various scenarios, some of the elements of the signaling shown can be performed concurrently, in a different order than shown, can be substituted for by one or more other signals, or can be omitted. Additional signaling can also be performed as desired.

Aspects of the signaling of FIG. 8C can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated signaling.

Note that while at least some signaling of FIG. 8C are described in a manner relating to the use of communication techniques and/or features associated with IEEE 802.11 specification documents, such description is not intended to be limiting to the disclosure, and aspects of the signaling of FIG. 8C can be used in any suitable wireless communication system, as desired. As shown, the signaling can operate as follows.

The signaling can begin with a non-access point wireless station (e.g., such as a baseband processor of a non-access point wireless station), such as non-AP STA 106, which can be a wireless station 106, detecting and/or initiating a QoS session at 802. Further, the non-AP STA 106 can receive, in unprotected frames such as multi-link (ML) probe response frame/beacon frame 806, QoS classes that can be supported by AP MLD M of AP 104. Upon receipt of the ML probe response frame/beacon frame, non-AP STA 106 can make an informed roaming/association decision, e.g., based, at least in part, on the indicated QoS classes that can be supported by AP MLD M. Foor example, based on the indicated QoS classes included in ML probe response frame/beacon frame 806, non-AP STA 106 can perform association with AP MLD M, e.g., via association request/response frame 808. Further, the non-AP STA 106 can then setup a QoS flow via roaming request frame 814 (e.g., which can include an SCSID, QoS characteristics, and so forth) and roaming response frame 816 (e.g., which can include the SCSID, and an indication of successful establishment of the QoS flow).

Thus, according to the signaling of FIG. 8C, it can be possible for a client to gain early knowledge about QoS support by an AP prior to association to a target AP MLD of the AP via proactive signaling from the AP, for example to provide better handling for low latency traffic during roaming events and/or performance degradation, among various possibilities. Such techniques can provide improved latency for QoS flows when roaming and/or provide any of a variety of other possible benefits, at least according to some embodiments.

In some instances, QoS classes can be defined to include a class ID corresponding to different categories/types of QOS flows, e.g., such as for virtual reality, augmented reality, extended reality, cloud gaming, a video call, a voice call, a high rate data transfer, and so forth. Further, a subclass ID can aid in addressing the evolution of QoS requirements for QoS flows within a QoS class ID. QoS parameters can include elements such as Minimum Service Interval, Maximum Service Interval, Minimum Data Rate, Delay Bound, and/or Direction (e.g., UL/DL/P2P). In addition, QoS classes can include experienced latency statistics (e.g., such as per MLD).

FIGS. 9A, 9B, and 9C illustrate various aspects of a QoS class information element, according to some embodiments. Note that the parameters and information elements (IEs) illustrated in FIGS. 9A, 9B, and 9C can be included in the signaling described above in reference to FIGS. 6, 7, 8A, 8B, and 8C as well as to any signaling described herein, e.g., the parameters and IEs can be included in frames described above in reference to FIGS. 6, 7, 8A, 8B, and 8C as well as to any frame described herein. As shown in FIG. 9A, a QoS class information element (IE) can include 1 octet for an element ID parameter, 1 octet for a length parameter, 1 octet for an element ID extension parameter, 2 octets for a count parameter, and/or variable octets for a QoS parameters set parameter. As shown in FIG. 9B, a QoS parameters set element can include 1 octet for a length parameter, 1 octet for a QoS class parameter, 1 octet for a QoS subclass parameter, 4 octets for a minimum service interval parameter, 4 octets for a maximum service interval parameter, 3 octets for a delay bound parameter, 1 octet for a direction parameter, and/or variable octets for additional parameters. As shown inf FIG. 9C, an example QoS parameters set may include values for both a QoS class and a QoS subclass, at least in some instances.

In some instances, to enhance roaming between AP MLDs of an AP, such as AP 104, an SCS agreement between a client, such as non-AP STA 106, and a current AP MLD of AP 104 can apply at a main MLD level (e.g., to all AP MLDs associated with an AP). Thus, an SCS identifier (SCSID) assigned to a QoS flow associated with the SCS agreement is unique across all AP MLDs of AP 104. Further, in such an arrangement, maintenance (e.g., change and/or update) of an existing SCS agreement can rely on the unique SCSID across AP (e.g., covering all AP MLDs of AP 104). For example, after the client roams to a target AP MLD of AP 104, the target AP MLD only needs to confirm whether the client can continue with current parameters indicated an QoS characteristics IE by sending an SCS response frame to the client and/or by including the QoS characteristics IE in a link add response frame. Note that the SCS response frame can be solicited or unsolicited. Note further that the target AP MLD can suggest alternative parameters (e.g., alternative QoS characteristics) to the client when/if a previous SCS agreement cannot be satisfied by the target AP MLD. In some instances, the client can (or can be required to) indicate a service start time for the target AP MLD so that the target AP MLD can start scheduling the client at the target AP MLD. Note that uplink, downlink, and/or peer-to-peer link can have independent (e.g., different, unique, and/or distinct) service start times. Further, a service start time link ID field of a QoS characteristics IE can be used to indicate the link whose target start frame (TSF) timer is used as a reference for the service start time. In some instances, a link ID field can be extended (e.g., increased from 4 octets to 6, 8, or more octets) to apply at the AP level. In other instances, <AP MLD, Link ID> can be used as an identifier since the SCS is identified at the AP level. Note that although the service start time will be with respect to the current AP MLD links, it will be translated to target AP MLD 2 TSFs.

In some instances, to enhance roaming between AP MLDs of an AP, such as AP 104, an SCS agreement between a client, such as non-AP STA 106, and a current AP MLD of AP 104 can remain at an AP MLD level and hence, an SCSID associated with a QoS flow of the SCS agreement will not be unique across the AP. In such an arrangement, maintenance (e.g., change and/or update) of an existing SCS agreement can rely on a local SCSID across each MLD. Further, during roaming, in order to avoid latencies and keep control with the client, a target AP MLD can be required to provide an update about the existing SCS agreement (e.g., confirming whether/if the existing SCS agreement will be supported or whether/if a change is needed). Note that such a scheme can include a mapping between the existing SCSID and a new SCSID (e.g., in case more than one SCS agreement exists). The update can solicited, e.g., via an SCS request frame, or can be unsolicited and triggered upon receipt at the target AP MLD of an add link request frame or upon receipt of data receive ready frames that are sent by the client to switch uplink and downlink data paths to the target AP MLD. Alternatively, or in addition, during roaming, in order to avoid latencies and keep control with the client, the client can setup a parallel (e.g., but inactive) SCS agreement at the target AP MLD while the existing SCS agreement is active at the current AP MLD. In such instances, suspension/resumption of the SCS agreement can depend on a service start time and/or a frame sent by the client. Note that the client can be required to indicate the service start time for the target AP MLD so that the Target AP MLD can start scheduling the client at the target AP MLD. Note that uplink, downlink, and/or peer-to-peer link can have independent (e.g., different, unique, and/or distinct) service start times. Note further that a service start time link ID field of a QoS characteristics IE can be used to indicate the link who TSF timer is used as a reference for the service start time.

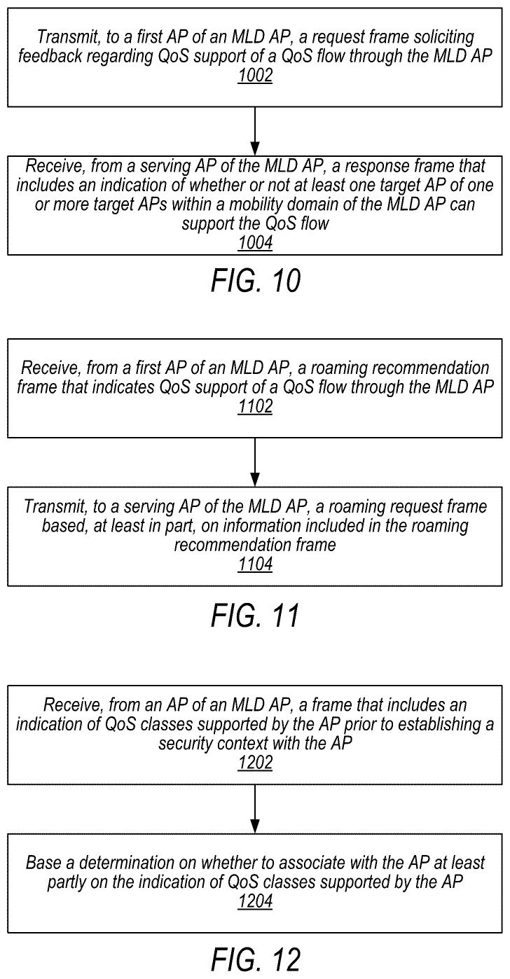

FIGS. 10, 11, and 12 are examples of methods for supporting early QoS assurance, according to some embodiments. In various scenarios, some of the elements of the methods shown can be performed concurrently, in a different order than shown, can be substituted for by one or more other elements, or can be omitted. Additional elements can also be performed as desired.

Aspects of the methods of FIGS. 10, 11, and 12 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements.

Note that while at least some elements of FIGS. 10, 11, and 12 are described in a manner relating to the use of communication techniques and/or features associated with IEEE 802.11 specification documents, such description is not intended to be limiting to the disclosure, and aspects of the methods of FIGS. 10, 11, and 12 can be used in any suitable wireless communication system, as desired. As shown, the methods can operate as follows.

Turning to FIG. 10, at 1002, a non-AP STA, such as STA 106, can transmit, to a first access point (AP) of a multi-link device (MLD) AP, e.g., such as AP 104, a request frame soliciting feedback regarding quality of service (QOS) support of a QoS flow through the MLD AP. Note that the first AP of the MLD AP can be within a mobility domain of the MLD AP.

In some instances, the request frame can include a request to continue a Stream Classification Service (SCS) agreement associated with the QoS flow. In such instances, the request frame can include an SCS identifier (ID) of the SCS agreement associated with the QoS flow.

In some instances, the request frame can include a QoS characteristics information element (IE). The QoS characteristics IE can include at least a description of the QoS flow. The description of the QoS flow can indicate a direction of the QoS flow, e.g., where the direction is at least one of uplink, downlink, or peer-to-peer. Additionally, the request frame can include at least one or more of (e.g., any, any combination of, and/or all of) a type classification (TCLAS) for uplink, a TCLAS for downlink, a TCLAS for peer-to-peer, a behavior aggregate (BA) classification, and/or an indication of one or more APs of interest.

In some instances, prior to transmitting the request frame, the non-AP STA can associate with the serving AP and transmit, to the serving AP, a Stream Classification Service (SCS) request frame to establish the QoS flow. In addition, the non-AP STA can receive, from the serving AP, an SCS response frame indicating establishment of the QoS flow.

In some instances, the request frame format can be based, at least in part, on a Stream Classification Service (SCS) request frame. In some instances, the request frame format can include an indication of an early request in an SCS Request Type parameter. In some instances, the request frame can be an action frame defined for roaming.

At 1004, the non-AP STA can receive, from a serving AP of the MLD AP, a response frame that includes an indication of whether or not at least one of one or more target APs within a mobility domain of the MLD AP can support the QoS flow. In some instances, the first AP can be the serving AP or the target AP.

In some instances, the response frame can include a timeout interval indicating a period of time that QoS flow support is assured by the target AP and a QoS characteristics information element (IE). In such instances, the non-AP STA can associate, prior to expiration of the timeout interval, with the target AP to assure QoS flow support.

The QoS characteristics IE can include at least a description of the QoS flow. The description of the QoS flow can indicate a direction of the QoS flow, e.g., where the direction is at least one of uplink, downlink, or peer-to-peer. Additionally, the QoS characteristics IE can include at least one or more of (e.g., any, any combination of, and/or all of) a type classification (TCLAS) for uplink, a TCLAS for downlink, a TCLAS for peer-to-peer, a behavior aggregate (BA) classification, and/or an indication of one or more APs of interest.

In some instances, the non-AP STA can determine, based on the response frame indicating that at least one target AP of the one or more target APs can support the QoS flow, to associate with the at least one target AP.

In some instances, when the response frame indicates that none of the one or more target APs can support the QoS flow, the response frame can include suggested changes to the QoS flow to allow at least one target AP of the one or more target APs to support an updated QoS flow. The suggested changes can include at least one of a reduced bandwidth or reduced data rate of the QoS flow.

In some instances, the QoS flow can be associated with a Stream Classification Service (SCS) agreement and the SCS agreement can be associated with an SCS identifier (SCSID). The SCSID can apply to the MLD AP and can be unique across all APs of the MLD AP or the SCSID can be a local SCSID and apply to AP and not be unique across all APs of the MLD AP.

In some instances, when the SCSID applies to the MLD AP and is unique across all APs of the MLD AP, the request frame can include the SCSID, and the response frame can also include the SCSID.

In some instances, when the SCSID is a local SCSID and applies to the serving AP, the non-AP STA can receive, from the target AP, an update regarding the SCS agreement, including a mapping between the SCSID and a new SCSID that applies to the target AP. In addition, the non-AP STA can establish, with the target AP, an SCS agreement associated with the new SCSID while the SCS agreement associated with the SCSID remains active with the serving AP.

Turning to FIG. 11, at 1102, a non-AP STA, such as STA 106, can receive, from a first access point (AP) of a multi-link device (MLD) AP, e.g., such as AP 104, a roaming recommendation or request frame that indicates quality of service (QOS) support of a QoS flow through the MLD AP. The roaming recommendation/request frame can include at least one or more of (e.g., any, any combination of, and/or all of) a list of candidate APs within a mobility domain of the MLD AP that can support an existing Stream Classification Service (SCS) agreement or an indication of QoS classes supported by candidate APs within a mobility domain of the MLD AP. The indication of QoS classes supported by candidate APs within a mobility domain of the MLD AP can be a QoS class information element (IE). The QoS class IE can include at least one or more of (e.g., any, any combination of, and/or all of) an element identifier (ID) parameter, a length parameter, an element ID extension parameter, a count parameter, and/or a QoS parameters set parameter. The QoS parameters set element can include at least one or more of (e.g., any, any combination of, and/or all of) a length parameter, a QoS class parameter, a QoS subclass parameter, a minimum service interval parameter, a maximum service interval parameter, a delay bound parameter, and/or a direction parameter. The QoS class parameter can include an identifier corresponding to a QoS flow associated with at least one of (e.g., any, any combination of, and/or all of) a QoS flow supporting a virtual reality application, a QoS flow supporting an augmented reality application, a QoS flow supporting an extended reality application, a QoS flow supporting a cloud gaming application, a QoS flow supporting a video call application, a QoS flow supporting a voice call application, and/or a QoS flow supporting a high rate data transfer application.

At 1104, the non-AP STA can transmit, to a serving AP of the MLD AP, a roaming request frame based, at least in part, on information included in the roaming recommendation/request frame. The roaming request/recommendation frame can include at least one or more of (e.g., any, any combination of, and/or all of) a Stream Classification Service (SCS) descriptor element or a QoS characteristics information element (IE). The QoS characteristics IE can include at least a description of the QoS flow. The description of the QoS flow can indicate a direction of the QoS flow, e.g., where the direction is at least one of uplink, downlink, or peer-to-peer. Additionally, the QoS characteristics IE can include at least one or more of (e.g., any, any combination of, and/or all of) a type classification (TCLAS) for uplink, a TCLAS for downlink, a TCLAS for peer-to-peer, a behavior aggregate (BA) classification, and/or an indication of one or more APs of interest. In at least some instances, the roaming recommendation/request frame can be a Link Reconfiguration Request frame and/or a variant of a Link Reconfiguration Request frame.

In some instances, the non-AP STA can receive, from the serving AP, a roaming response frame, wherein the roaming response frame includes at least one or more of (e.g., any, any combination of, and/or all of) an SCS status list, an SCS descriptor element, and/or a QoS characteristics IE. The roaming response frame can confirm continuation of an SCS agreement associated with the QoS flow and can indicate necessary parameters for a service start time. In at least some instances, the roaming response frame can be a Link Reconfiguration Response frame and/or a variant of a Link Reconfiguration Response frame.

In some instances, the QoS flow can be associated with a Stream Classification Service (SCS) agreement and the SCS agreement can be associated with an SCS identifier (SCSID). The SCSID can apply to the MLD AP and can be unique across all APs of the MLD AP or the SCSID can be a local SCSID and apply to AP and not be unique across all APs of the MLD AP.

In some instances, when the SCSID applies to the MLD AP and is unique across all APs of the MLD AP, the request frame can include the SCSID, and the response frame can also include the SCSID.

In some instances, when the SCSID is a local SCSID and applies to the serving AP, the non-AP STA can receive, from the target AP, an update regarding the SCS agreement, including a mapping between the SCSID and a new SCSID that applies to the target AP. In addition, the non-AP STA can establish, with the target AP, an SCS agreement associated with the new SCSID while the SCS agreement associated with the SCSID remains active with the serving AP.

Turning to FIG. 12, at 1202, a non-AP STA, such as STA 106, can receive, from an access point (AP) of a multi-link device (MLD) AP, e.g., such as AP 104, a frame that includes an indication of QoS classes supported by the AP prior to establishing a security context with the AP. The indication of QoS classes supported by the AP can be a QoS class information element (IE). The QoS class IE can include at least one or more of (e.g., any, any combination of, and/or all of) an element identifier (ID) parameter, a length parameter, an element ID extension parameter, a count parameter, and/or a QoS parameters set parameter. The QoS parameters set element can include at least one or more of (e.g., any, any combination of, and/or all of) a length parameter, a QoS class parameter, a QoS subclass parameter, a minimum service interval parameter, a maximum service interval parameter, a delay bound parameter, and/or a direction parameter. The QoS class parameter can include an identifier corresponding to a QoS flow associated with at least one of (e.g., any, any combination of, and/or all of) a QoS flow supporting a virtual reality application, a QoS flow supporting an augmented reality application, a QoS flow supporting an extended reality application, a QoS flow supporting a cloud gaming application, a QoS flow supporting a video call application, a QoS flow supporting a voice call application, and/or a QoS flow supporting a high rate data transfer application.

At 1204, the non-AP STA can base a determination on whether to associate with the AP at least partly on the indication of QoS classes supported by the AP.

In some instances, the non-AP STA can associate, based, at least in part, on the indication of QoS classes supported by the AP, with the AP. In addition, the non-AP STA can transmit, to the AP, a Stream Classification Server (SCS) request frame to establish a quality of service (QOS) flow with the AP and receive, from the AP, an SCS response frame confirming the QoS flow establishment. The SCS request frame can include at least one or more of (e.g., any, any combination of, and/or all of) a Stream Classification Service (SCS) descriptor element or a QoS characteristics information element (IE). The QoS characteristics IE can include at least a description of the QoS flow. The description of the QoS flow can indicate a direction of the QoS flow, e.g., where the direction is at least one of uplink, downlink, or peer-to-peer. Additionally, the QoS characteristics IE can include at least one or more of (e.g., any, any combination of, and/or all of) a type classification (TCLAS) for uplink, a TCLAS for downlink, a TCLAS for peer-to-peer, a behavior aggregate (BA) classification, and/or an indication of one or more APs of interest. In addition, the SCS response frame can indicate necessary parameters for a service start time. Further, the QoS flow can be associated with an SCS agreement and the SCS agreement can be associated with an SCS identifier (SCSID). The SCSID can apply to the MLD AP and can be unique across all APs of the MLD AP. Further, the SCS request frame can include the SCSID and the SCS response frame can include the SCSID.

In some instances, the non-AP STA can associate, based, at least in part, on the indication of QoS classes supported by the AP, with the AP. In addition, the non-AP STA can transmit, to the AP, a roaming request frame to establish a quality of service (QOS) flow with the AP and receive, from the AP, a roaming response frame confirming the QoS flow establishment. The roaming request frame can include at least one or more of (e.g., any, any combination of, and/or all of) a Stream Classification Service (SCS) descriptor element or a QoS characteristics information element (IE). The QoS characteristics IE can include at least a description of the QoS flow. The description of the QoS flow can indicate a direction of the QoS flow, e.g., where the direction is at least one of uplink, downlink, or peer-to-peer. Additionally, the QoS characteristics IE can include at least one or more of (e.g., any, any combination of, and/or all of) a type classification (TCLAS) for uplink, a TCLAS for downlink, a TCLAS for peer-to-peer, a behavior aggregate (BA) classification, and/or an indication of one or more APs of interest. In addition, the roaming response frame can indicate necessary parameters for a service start time. Further, the QoS flow can be associated with a roaming agreement and the SCS agreement can be associated with an SCS identifier (SCSID). The SCSID can apply to the MLD AP and can be unique across all APs of the MLD AP. Further, the roaming request frame can include the SCSID, and the roaming response frame can include the SCSID.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
transmitting, to a first access point (AP) of a multi-link device (MLD) AP, a request frame soliciting feedback regarding quality of service (QOS) support of a QoS flow through the MLD AP; and
receiving, from a serving AP of the MLD AP, a response frame that includes an indication of whether or not at least on target AP of one or more target APs within a mobility domain of the MLD AP can support the QoS flow.

2. The method of claim 1, further comprising:
determining, based on the response frame indicating that at least one target AP of the one or more target APs can support the QoS flow, to associate with the at least one target AP.

3. The method of claim 1,
wherein, prior to transmitting the request frame, the method further comprises:
associating with the serving AP;
transmitting, to the serving AP, a Stream Classification Service (SCS) request frame to establish the QoS flow; and
receiving, from the serving AP, an SCS response frame indicating establishment of the QoS flow.

4. The method of claim 1,
wherein the first AP comprises the serving AP.

5. The method of claim 1,
wherein the first AP comprises the target AP.

6. The method of claim 1,
wherein the request frame includes a request to continue a Stream Classification Service (SCS) agreement associated with the QoS flow.

7. The method of claim 6,
wherein the request frame includes an SCS identifier (ID) of the SCS agreement associated with the QoS flow.

8. The method of claim 1,
wherein the request frame includes a QoS characteristics information element (IE).

9. The method of claim 8,
wherein the QoS characteristics IE includes at least a description of the QoS flow.

10. The method of claim 9,
wherein the description of the QoS flow indicates a direction of the QoS flow, wherein the direction is at least one of uplink, downlink, or peer-to-peer.

11. The method of claim 8,
wherein the request frame includes at least one or more of:
a type classification (TCLAS) for uplink;
a TCLAS for downlink;
a TCLAS for peer-to-peer;
a behavior aggregate (BA) classification; or
an indication of one or more APs of interest.

12. A wireless device, comprising:
one or more antennas;
one or more radios operably coupled to the one or more antennas; and
a processor operably coupled to the one or more radios;
wherein the processor is configured to cause the wireless device to:
receive, from a first access point (AP) of a multi-link device (MLD) AP, a roaming recommendation frame that indicates quality of service (QOS) support of a QoS flow through the MLD AP; and
transmit, to a serving AP of the MLD AP, a roaming request frame based, at least in part, on information included in the roaming recommendation frame.

13. The wireless device of claim 12,
wherein the roaming recommendation frame includes at least one or more of:
a list of candidate APs within a mobility domain of the MLD AP that can support an existing Stream Classification Service (SCS) agreement; or
an indication of QoS classes supported by candidate APs within the mobility domain of the MLD AP.

14. The wireless device of claim 13,
wherein the indication of QoS classes supported by candidate APs within the mobility domain of the MLD AP is a QoS class information element (IE).

15. The wireless device of claim 14,
wherein the QoS class IE includes at least one or more of:
an element identifier (ID) parameter;
a length parameter;
an element ID extension parameter;
a count parameter; or
a QoS parameters set parameter.

16. The wireless device of claim 12,
wherein the roaming request frame includes at least one or more of:
a Stream Classification Service (SCS) descriptor element; or
a QoS characteristics information element (IE).

17. A non-transitory computer readable memory medium storing instructions executable by a processor to:
receive, from an access point (AP) of a multi-link device (MLD) AP, a frame that includes an indication of QoS classes supported by the AP prior to establishing a security context with the AP; and
base a determination on whether to associate with the AP at least partly on the indication of QoS classes supported by the AP.

18. The non-transitory computer readable memory medium of claim 17
wherein the instructions are further executable by the processor to:
associate, based, at least in part, on the indication of QoS classes supported by the AP, with the AP.

19. The non-transitory computer readable memory medium of claim 18,
wherein the instructions are further executable by the processor to:
transmit, to the AP, a Stream Classification Server (SCS) request frame to establish a quality of service (QOS) flow with the AP; and
receive, from the AP, an SCS response frame confirming the QoS flow establishment.

20. The non-transitory computer readable memory medium of claim 17,
wherein the instructions are further executable by the processor to:
transmit, to the AP, a roaming request frame to establish a quality of service (QOS) flow with the AP; and
receive, from the AP, a roaming response frame confirming the QoS flow establishment.
